(19) United States
(12) Patent Application Publication
(10) Pub. No.: US 2006/0042663 A1
(43) Pub. Date: Mar. 2, 2006

(54) Method for removing iron deposits from within closed loop systems

(75) Inventors: David N. Fulmer, Missouri City, TX (US); James R. Waterfallen, Kingwood, TX (US); Brian George, Spring, TX (US)

Correspondence Address: MADAN, MOSSMAN & SRIRAM, P.C., 2603 AUGUSTA, SUITE 700, HOUSTON, TX, 77057, US

(73) Assignee: Baker Hughes Incorporated, Houston, TX (US)

(21) Appl. No.: 10/925,646

(22) Filed: Aug. 25, 2004

(51) Int. Cl. B08B 9/00

(52) U.S. Cl. 134/26; 134/22.1

(57) ABSTRACT

Diethylhydroxylamine (DEHA) and di-isopropylhydroxylamine can be used to remove iron deposits from the surfaces of closed loop systems. A closed loop system can be cleaned of iron deposits by first contacting the surface of the closed loop system having iron deposits with an aqueous solution of an oxygen scavenger; and then introducing diethylhydroxylamine, di-isopropylhydroxylamine, or mixtures thereof; into the closed loop system at a concentration sufficient to cause the iron deposits to release from the surface of the closed loop system. It can be desirable to use a filter or strainer to trap and remove the particulate iron deposits once they have been released from the surface of the closed loop system. In the alternative, a dispersant can be used to prevent released particulate iron deposits from reforming as scale.

### BACKGROUND OF THE INVENTION

1. Field of the Invention

The present invention relates to a method for removing iron deposits from within closed loop systems. The present invention particularly relates to a method for removing iron deposits from within a closed loop system using a chemical cleaning agent.

2. Background of the Art

Closed loop systems, for the purposes of the present invention, mean systems that can be isolated from atmospheric oxygen. Exemplary closed loops systems include boilers, cooling water systems, gas scrubbers, pipelines, desalination systems, storage tanks, and the like.

It is well known that the internal metallic surfaces in contact with water, particularly ferrous surfaces, tend to pick up iron fouling. This fouling can form a layer that may have one or more of several undesirable effects. For example, where the closed loop system is used for heat transfer such as cooling or heating, this layer can act an insulator that not only reduces heat flow through the system, but also reduces volume capacity of the system. Such a layer can promote corrosion. In systems wherein the inside of the system is visible, the layer of iron fouling can be ascetically undesirable.

Many cleaning procedures for removing iron fouling are known. For example, the use of hydrochloric acid, which removes Fe as soluble FeCl₃, or citric acid or ammonium citrate, which remove Fe as a water-soluble complex is well known. U.S. Pat. No. 4,581,074 discloses a method for cleaning and removing iron oxide deposits from the internal heat transfer surfaces of boiler tubes. The disclosed invention includes purging the tubes with superheated steam and oxygen driven at a speed of 20 to 80 m/sec. The process is said to both clean and passivate the metal surfaces of the tubes.

U.S. Pat. No. 4,721,532 discloses a method of removing iron fouling from heat transfer surfaces of cooling water systems comprising the steps of (a) contacting the surfaces with an aqueous solution containing an effective amount, totaling at least 0.1 ppm, of at least one compound of the group of alkylene amine carboxyl polyacids. U.S. Pat. No. 4,721,532 discloses certain alkylene amine carboxyl polyacids (AACPs) which are useful for removing iron fouling from heat transfer surfaces of cooling water systems. Particularly preferred compounds disclosed therein are N,N′-ethylene-bis-((2-hydroxy-4-methylphenyl)glycine) (EDDHMA) and N,N-di-(2-hydroxy-5-sulfonic acid benzyl) glycine, (Hamplex DPS). U.S. Pat. No. 5,183,573 discloses that 3,5-bis(di-N,N-(carboxymethyl)aminomethyl)-4-hydroxybenzenesulfonic acid is useful in chelating not only iron but also effectively chelating calcium ions in aqueous solutions and is thus effective at preventing and removing both calcium and rust scale deposits.

U.S. Pat. No. 5,015,298 discloses yet another method of cleaning metal surfaces. In the practice of this invention, a metal surface is contacted with an aqueous cleaning composition comprising an acid selected from the group consisting of polycarboxylic acids and polyphosphonic acids, and at least one base selected from the group consisting of alkali metal hydroxides, alkali metal carbonates and alkali metal phosphates. It is disclosed that the aqueous cleaning composition can be used to passivate the metal surface after iron containing deposits are removed therefrom.

Various patents disclose the use of hydroxylamine and similar compounds as an oxygen scavenger in high temperature, high pressure aqueous systems. For example, U.S. Pat. No. 4,067,690 teaches the use of hydroxylamine, certain derivatives thereof and their salts as oxygen scavengers in boiler water. U.S. Pat. No. 5,256,311 teaches the use of hydroxyalkylhydroxylamine as an oxygen scavenger in high temperature, high pressure aqueous mediums. Similarly, U.S. Pat. No. 4,278,635 discloses use of dihydroxy, diamino and amino hydroxy benzenes and their lower alkyl substituted derivatives as deoxygenating corrosion control agents.

### SUMMARY OF THE INVENTION

In one aspect, the present invention is a method for removing iron deposits from the surface of a closed loop system comprising the steps of: (a) contacting the surface of the closed loop system having iron deposits with an aqueous solution of an oxygen scavenger; and (b) introducing diethylhydroxylamine into the closed loop system at a concentration sufficient to cause the iron deposits to release from the surface of the closed loop system; wherein the dialkylhydroxylamine is selected from the group consisting of diethylhydroxylamine, di-isopropylhydroxylamine, and mixtures thereof.

In another aspect, the present invention is a method for removing iron deposits from the surface of a closed loop system comprising the steps of: (a) contacting the surface of the closed loop system having iron deposits with an aqueous solution of an oxygen scavenger; (b) introducing diethylhydroxylamine into the system at a concentration sufficient to cause the iron deposits to release from the surface of the closed loop system; and (c) introducing a dispersant into the system; wherein the dialkylhydroxylamine is selected from the group consisting of diethylhydroxylamine, di-isopropylhydroxylamine, and mixtures thereof.

Another aspect of the present invention is a method for removing iron deposits from the surface of a closed loop system comprising the steps of: (a) contacting the surface of the closed loop system having iron deposits with an aqueous solution of an oxygen scavenger; and (b) introducing dialkylhydroxylamine into the closed loop system at a concentration sufficient to cause the iron deposits to release from the surface of the closed loop system; wherein the dialkylhydroxylamine is diethylhydroxylamine.

In yet another aspect, the present invention is a method for removing iron deposits from the surface of a closed loop system comprising the steps of: (a) contacting the surface of the closed loop system having iron deposits with an aqueous solution of an oxygen scavenger; and (b) introducing dialkylhydroxylamine into the closed loop system at a concentration sufficient to cause the iron deposits to release from the surface of the closed loop system; wherein the dialkylhydroxylamine is di-isopropylhydroxylamine.

### DESCRIPTION OF THE PREFERRED EMBODIMENTS

In one embodiment, the present invention is a method for removing iron deposits from the surface of a closed loop system. As already defined above, the term closed loop systems means systems that can be isolated from atmospheric oxygen. Exemplary closed loops systems include boilers, cooling water systems, pipelines, desalination systems, storage tanks, and the like. Any system of pipes and vessels, whatever its purpose, that can be isolated from atmospheric oxygen or other oxidizers and can be contacted with an aqueous fluid can be cleaned of iron deposits with the method of the present invention. In the practice of the present invention, the closed loop systems will preferably have a circulation of water or at least an aqueous solution present for use as a medium of application for the chemical agents of the present application. In some embodiment, the closed loop system may have a static body of water present in which case the chemical agents used with the present invention will be dispersed by diffusion or stirring.

The iron deposits that are removed with the method of the present invention are often referred to in the art as iron fouling, iron crusts or iron scale. These deposits are iron compounds that build up on the internals of closed loop systems such as the heat transfer surfaces of cooling water systems. This iron can be present in various forms, including, but not limited to oxides, hydroxides, and sulfides. The iron deposits of the present invention may include complex forms bound with calcium and/or magnesium.

In the practice of the method of the present invention, a dialkylhydroxylamine (DAHA) is introduced into a closed loop system at a concentration sufficient to cause the iron deposits to release from the surface of the closed loop system. In the practice of the present invention, the DAHA is an N,N-dialkylhydroxylamine wherein the alkyl groups are both either ethyl groups or isopropyl groups or a mixture of diethylhydroxylamine or di-isopropylhydroxylamine. Stated another way, the method of the present invention can be practiced wherein the DAHA is selected from the group consisting of diethylhydroxylamine, di-isopropylhydroxylamine, and mixtures thereof.

The method of Claim 1 wherein the oxygen scavenger is added in a quantity sufficient to reduce substantially all of any compound or compounds present that could oxidize dialkylhydroxylamine

In the method of the present invention, before the DAHA is introduced, the closed loop system is treated with an oxygen scavenger to remove oxygen and chlorine and other oxidizing compounds from the system. The oxygen scavenger is preferably added in a quantity sufficient to reduce substantially all of any compound or compounds present that could oxidize dialkylhydroxylamine to avoid consumption of the DAHA. For purposes of the present invention, the term substantially all means from about 20 to about 100 percent, preferably from about 50 to about 100 percent and most preferably from about 80 to 100 percent.

The oxygen scavengers useful with the present invention are chemical reducing agents including, but not limited to: sulphite and bisulfite salts, hydrazine, hydroxylamines other than diethylhydroxylamine and di-isopropylhydroxylamine, carbohydrazides, hydroquinones, hydroquinones in combination with various amines which do not cause precipitation of the hydroquinone, reduced methylene blue, mixtures of hydroxylamine and neutralizing amines, dihydroxy acetones and combinations thereof with hydroquinone and other catalysts, ascorbic acid, and erythorbic acid, particularly as ammonia or amine neutralized salts, catalyzed hydrazines where the catalysts may include complex cobalt salts, other catalyzed hydroquinone compositions, and various combinations of all the above, including but not limited to hydroquinone in combination with various neutralizing amines and in turn combined with erythorbic or ascorbic acid, carbohydrazide, and salicylaldehyde catalyzed hydroquinone. In one embodiment of the present invention the oxygen scavenger is a sulphite salt, a bisulfite salt and mixtures thereof. In another embodiment, the oxygen scavenger is sodium bisulfite.

The DAHA is introduced into a closed loop system after the oxygen and other oxidizing agents have been scavenged. The delay between these two steps can be short or long depending upon the conditions of the system. For example, if the closed loop system is being run at a very high temperature, then the oxygen scavengers will most likely be quick acting and the addition of the DAHA can be almost simultaneous. If, on the other hand, the system is being run at a low temperature, then the oxygen scavengers should be allowed sufficient time to substantially fully reduce all of the oxidizing agents present in the system before the introducing the DAHA. In one embodiment of the present invention, the oxidative potential of the fluid in the closed loop system is tested prior to introducing the DAHA to assure that little or no DAHA is consumed by oxidizing agents. In another embodiment of the present invention, the oxygen scavenger loading for the fluid in the closed loop system is calculated, the calculated amount of oxygen scavenger is added to the closed loop system, the oxygen scavenger is allowed to circulate within the closed loop system, and then the DAHA is added to the closed loop system.

The calculation of oxygen scavenger loading is well known in the art of cleaning and maintaining closed loop systems, such as boilers, chilled water systems, and the like. For example, one method of determining the concentration of oxygen scavenger in boiler water is to do a chemical calorimetric titration. EP-A 614085 discloses a method for directly measuring the concentration of one or more water treatment compositions in a steam generating system which comprises directly determining an absorbance or emission spectrum of the system water in the wavelength range of from 200 to 2500 nm, and applying chemometrics algorithms to the absorbance or emission spectrum to determine the concentration of the water treatment compositions. In the practice of the present invention, any method to determine scavenger requirements and concentrations can be used so long as the oxygen scavenger is added in a quantity sufficient to reduce substantially all of any compound or compounds present that could oxidize significant amounts of the DAHA added in the next step of the method.

In the practice of the method of the present invention, DAHA is introduced into a closed loop system at a concentration sufficient to cause iron deposits to release from the surface of the closed loop system. For most closed loop systems, the concentration of DAHA necessary to achieve this objective is from about 3 to about 500 parts per million (ppm) DAHA in the total solution within the closed loop system. For other closed loop systems, the concentration of DAHA necessary to achieve this objective is from about 10 to about 80 parts per million (ppm). For still other closed loop systems, the concentration of DAHA necessary to achieve this objective is from about 30 to about 50 parts per million (ppm). For the purposes of the present invention, the term parts per million is determined as milligrams of DAHA per liter of fluid within the closed loop system.

The method of the present invention can be practiced at any temperature so long as the residence time of the chemical agents used is sufficient to achieve the purpose of their use. As already stated above, in low temperature applications, the antioxidant may not be effective enough to allow for immediate addition of the DAHA. Similarly, the DAHA may require longer residence times in lower temperature systems. In one embodiment, the method of the present invention is performed at a temperature of from about 0° C. to about 100° C. In another embodiment, the method of the present invention is performed at a temperature of from 10° C. to about 90° C. In still another embodiment, the method of the present invention is performed at a temperature of from 25° C. to about 70° C.

Once the iron deposits have been released from the surface of the closed loop system, it is often desirable and even important to remove the iron deposits from the close loop system. For example, if not removed or at least stably dispersed, the deposits could re-form as scale. This can be done by any method known to those of ordinary skill in the art of cleaning and maintinaing a closed loop system. For example, the released deposits can be caught in filters of many types. Depending upon the size of the particles of iron deposits released in the practice of the present invention, the released deposits can even be caught in strainers.

In one embodiment of the present invention, the iron deposit solids are dispersed using a dispersant. Dispersants useful with the present invention are those known as water soluble polymers. Included in these dispersants are water soluble polymers prepared from an allyloxybenzenesulfonic acid monomer, a methallylsulfonic acid monomer, a copolymerizable nonionic monomer, and a copolymerizable olefinically unsaturated carboxylic acid monomer. The polymers are used to disperse particulate matter and to inhibit the formation and deposition of mineral scale in aqueous systems and are used in detergent compositions. These polymers are disclosed in EP-B 7274048 the entire contents of which are included herein by reference. Other dispersants that may be useful with the present invention include those disclosed in: U.S. Pat. No. 4,892,898, which discloses water soluble polymers of allyloxybenzenesulfonate monomers and one or more copolymerizable monomers; U.S. Pat. No. 4,709,091, which discloses polymers of maleic acid and sodium methallylsulfonate which may be used as a dispersing agent and a scaling inhibitor; U.S. Pat. No. 4,711,725, which discloses processes for stabilizing aqueous systems containing scale forming salts and inorganic particulates by adding to such systems low molecular weight water soluble polymers which contain methacrylic acid units, acrylamido alkyl or aryl sulfonate units and one or more units selected from vinyl esters, vinyl acetate and substituted acrylamides; U.S. Pat. No. 4,504,643, which discloses a water soluble methacrylic acid/methallylsulfonate copolymer and a scale inhibitor for aqueous environments; U.S. Pat. No. 4,451,628, which discloses low molecular weight water soluble polymers made by copolymerizing methallylsulfonic acid, or the alkali metal salts thereof, with water soluble monomers, which polymers may be used as dispersants or scale inhibitors.

Any dispersant that can be used to disperse the iron deposits released from the surface of the closed loop system being cleaned using the method of the present invention can be used with the method of the present invention. In one embodiment of the present invention, the dispersant is a copolymer of acrylic acid and 2-acrylamindo-2-methyl propane sulfonic acid. In another embodiment, the dispersant is a poly acrylic acid. In yet another embodiment, the dispersant is a poly maleic acid. In still another embodiment, the dispersant is a terpolymer of acrylic acid, 2-acrlamido-2-methyl propane sulfonic acid, and sulfonated styrene.

In the practice of the present invention, other materials can be added to the closed loop reactor system to facilitate or enhance the iron deposit removal process. These other materials, often referred to as additives include, but are not limited to: detergents, ion exchangers, alkalis, anticorrosion materials, antiredeposition materials, optical brighteners, fragrances, dyes, fillers, chelating agents, enzymes, defoarners, solvents, hydrotropes, bleaching agents, bleach precursors, buffering agents.

### EXAMPLE

The following example is provided to illustrate the present invention. The example is not intended to limit the scope of the present invention and it should not be so interpreted. Amounts are in weight parts or weight percentages unless otherwise indicated.

### Hypothetical Example

A chilled water loop is first treated with a sodium bisulfite oxygen scavenger at a level sufficient to remove all measurable amounts of chlorine and oxygen. After the system has been tested to ensure that oxygen and chlorine have been effectively scavenged, the circulating water in the chilled water system is treated with sufficient diethylhydroxylamine to achieve a concentration of 3 ppm within the chilled water system. The system is then treated with 50 ppm DTrac 435 dispersant. The system is then treated with an 50 ppm of isothiazolin.

The concentration of diethylhydroxylamine is monitored and slowly increased until the concentration of iron in the circulating water peaks. The system is then monitored to ensure that the level of DTrac 435 dispersant is maintained at 5 ppm in the circulating water.

What is claimed is:

1. A method for removing iron deposits from the surface of a closed loop system comprising the steps of:
(a) contacting the surface of the closed loop system having iron deposits with an aqueous solution of an oxygen scavenger; and
(b) introducing dialkylhydroxylamine into the closed loop system at a concentration sufficient to cause the iron deposits to release from the surface of the closed loop system;
wherein the dialkylhydroxylamine is selected from the group consisting of diethylhydroxylamine, di-isopropylhydroxylamine, and mixtures thereof.

2. The method of claim 1 further comprising introducing a dispersant concurrently with the addition of the dialkylhydroxylamine.

3. The method of claim 1 further comprising introducing a dispersant concurrently with the addition of the oxygen scavenger.

4. The method of claim 3 further comprising collecting and removing the released iron deposits from the closed loop system.

5. The method of claim 1 wherein the oxygen scavenger is selected from the group consisting of a sulphite salt, a bisulfite salt and mixtures thereof.

6. The method of claim 5 wherein the oxygen scavenger is sodium bisulfite.

7. The method of claim 1 wherein the oxygen scavenger is added in a quantity sufficient to reduce substantially all of any compound or compounds present that could oxidize dialkylhydroxylamine.

8. The method of claim 1 wherein the concentration of dialkylhydroxylamine sufficient to cause the iron deposits to release from the surface of the closed loop system is from about 3 to about 500 ppm of water or aqueous solution present in the closed loop system.

9. The method of claim 8 wherein the concentration of dialkylhydroxylamine sufficient to cause the iron deposits to release from the surface of the closed loop system is from about 10 to about 80 ppm.

10. The method of claim 8 wherein the concentration of dialkylhydroxylamine sufficient to cause the iron deposits to release from the surface of the closed loop system is from about 30 to about 50 ppm.

11. The method of claim 2 wherein the dispersant is a water soluble polymer.

12. The method of claim 11 wherein the dispersant is a copolymer of acrylic acid and 2-acrylamido-2-methyl propane sulfonic acid.

13. The method of claim 3 wherein the dispersant is a water soluble polymer.

14. The method of claim 13 wherein the dispersant is a copolymer of acrylic acid and 2-acrylamido-2-methyl propane sulfonic acid.

15. A method for removing iron deposits from the surface of a closed loop system comprising the steps of:
(a) contacting the surface of the closed loop system having iron deposits with an aqueous solution of an oxygen scavenger;
(b) introducing dialkylhydroxylamine into the system at a concentration sufficient to cause the iron deposits to release from the surface of the closed loop system; and
(c) introducing a dispersant into the system;
wherein the dialkylhydroxylamine is selected from the group consisting of diethylhydroxylamine, di-isopropylhydroxylamine, and mixtures thereof.

16. The method of claim 15 wherein the oxygen scavenger is selected from the group consisting of a sulphite salt, a bisulfite salt and mixtures thereof.

17. The method of claim 16 wherein the oxygen scavenger is sodium bisulfite.

18. The method of claim 17 wherein the oxygen scavenger is added in a quantity sufficient to reduce substantially all of any compound or compounds present that could oxidize dialkylhydroxylamine.

19. The method of claim 15 wherein the concentration of dialkylhydroxylamine sufficient to cause the iron deposits to release from the surface of the closed loop system is from about 3 to about 100 ppm of water or aqueous solution present in the closed loop system.

20. The method of claim 15 wherein the dispersant is a water soluble polymer.

21. The method of claim 20 wherein the dispersant is a copolymer of acrylic acid and 2-acrylamido-2-methyl propane sulfonic acid.

22. A method for removing iron deposits from the surface of a closed loop system comprising the steps of:
(a) contacting the surface of the closed loop system having iron deposits with an aqueous solution of an oxygen scavenger; and
(b) introducing dialkylhydroxylamine into the closed loop system at a concentration sufficient to cause the iron deposits to release from the surface of the closed loop system;
wherein the dialkylhydroxylamine is diethylhydroxylamine.

23. A method for removing iron deposits from the surface of a closed loop system comprising the steps of:
(a) contacting the surface of the closed loop system having iron deposits with an aqueous solution of an oxygen scavenger; and
(b) introducing dialkylhydroxylamine into the closed loop system at a concentration sufficient to cause the iron deposits to release from the surface of the closed loop system;
wherein the dialkylhydroxylamine is di-isopropylhydroxylamine.
